(19) United States
(12) Patent Application Publication
(10) Pub. No.: US 2006/0066610 A1
(43) Pub. Date: Mar. 30, 2006

(54) Method, device, and computer program product for displaying 3D grid in designing configuration model

(75) Inventors: Yasuhiro Asano, Kawasaki (JP); Terutoshi Taguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/036,349

(22) Filed: Jan. 18, 2005

(30) Foreign Application Priority Data
Sep. 29, 2004 (JP) 2004-284253

(51) Int. Cl. G06T 15/00

(52) U.S. Cl. 345/419

(57) ABSTRACT

Grid space designation information and grid plane designation information are acquired. The grid space designation information includes a width of the three-dimensional grid and a distance between two points of the three-dimensional grids. The grid plane designation information includes a display width of the three-dimensional grid and a display position at which the three-dimensional grid is to be displayed. Only that portion of the three-dimensional grids that is defined by the grid space designation information and the grid plane designation information is displayed.

### BACKGROUND OF THE INVENTION

1) Field of the Invention

The present invention relates to a technology that helps in designing a model configuration using a three-dimensional grid (3D grid).

2) Description of the Related Art

A technology called CAD (Computer Aided Designing) is used when designing a model configuration. It is expected that the CAD software produces in a short time a design that is very near to what the model the designer or the operator has in his mind. To respond to this expectation, the CAD software often requires the designer to set a reference point on the model.

Japanese Patent Application Laid-open Publication No. 2000-48065 discloses a method of plotting a virtual pipeline by displaying a grid on three-dimensional coordinates, then designating coordinates of both ends of the pipeline, and connecting the coordinates designated by a cylindrical column. Moreover, Japanese Patent Specification No. 2748972 discloses a method of determining input coordinates based on information related to a grid selected upon superimposing a plurality of grids for which a distance between lattice points is different.

However, in the conventional technology, while displaying a grid in a three-dimensional space, the grid is displayed even in an area that is not intended by the designer. Therefore, it makes it difficult to draw a schematic diagram of the model configuration, and the efficiency of designing reduces.

### SUMMARY OF THE INVENTION

It is an object of the present invention to at least solve the problems in the conventional technology.

A method according to an aspect of the present invention is a method of displaying a three-dimensional grid in designing a model configuration. The method includes acquiring grid space designation information that designates a width of the three-dimensional grid and a distance between two points of the three-dimensional grid; acquiring grid plane designation information that designates a display width of the three-dimensional grid and a display position at which the three-dimensional grid is to be displayed; and displaying only that portion of the three-dimensional grids that is defined by the grid space designation information and the grid plane designation information.

A device according to another aspect of the present invention displays a three-dimensional grid in designing a model configuration. The device includes a first acquiring unit that acquires grid space designation information that designates a width of the three-dimensional grid and a distance between two points of the three-dimensional grid; a first acquiring unit that acquires grid plane designation information that designates a display width of the three-dimensional grid and a display position at which the three-dimensional grid is to be displayed; and a displaying unit that displays only that portion of the three-dimensional grids that is defined by the grid space designation information and the grid plane designation information.

The computer program product according to still another aspect of the present invention implements the above method on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of a structure of a configuration designing supporting unit according to a first embodiment;

FIG. 2 is a diagram in which a dotted 3D-grid created by a 3D grid creating section;

FIG. 3 is a diagram in which a line 3D-grid created by the 3D grid creating section;

FIG. 4 illustrates 3D grid data that is stored in a 3D grid storage;

FIG. 5 illustrates snapping of a pointer of an input unit to the 3D grid by a 3D grid retrieving processor;

FIG. 6 is an example of 3D grid plane that is displayed on a display unit by a grid plane display processor via a display controller;

FIG. 7 is an example of a data structure of the 3D grid plane;

FIG. 8 is an illustration to describe a display color of the 3D grid plane;

FIG. 9 is a flowchart of a process procedure for creating a 3D grid, executed by the 3D grid creating section;

FIG. 10 is a flowchart of a process procedure executed by the 3D grid creating section when changing a width of the 3D grid;

FIG. 11 is a flowchart of a process procedure executed by the 3D grid creating section when changing a distance between the 3D grids;

FIG. 12 is a flowchart of a process procedure executed by the 3D grid creating section when deleting the 3D grid;

FIG. 13 is a flowchart of a process procedure executed by the grid plane display processor when displaying the 3D grid plane on the display unit via the display controller;

FIG. 14 is a flowchart of a process procedure executed by a grid plane editor when changing a display widht of the 3D grid plane;

FIG. 15 is a flowchart of a process procedure executed by the grid plane editor when changing a position of the 3D grid plane;

FIG. 16 is a flowchart of a process procedure, executed by the grid plane editor when copying the 3D grid plane;

FIG. 17 is a flowchart of a process procedure executed by the grid plane editor when deleting the 3D grid plane; and

FIG. 18 is a diagram of a computer that executes a computer program to support the configuration designing.

### DETAILED DESCRIPTION

Exemplary embodiments of the present invention are described in detail with reference to the accompanying drawings.

A configuration designing supporting unit according to a first embodiment displays a grid, used by a designer while designing a configuration, only in a range and a position desired by the designer and not in the whole of a three-dimensional space.

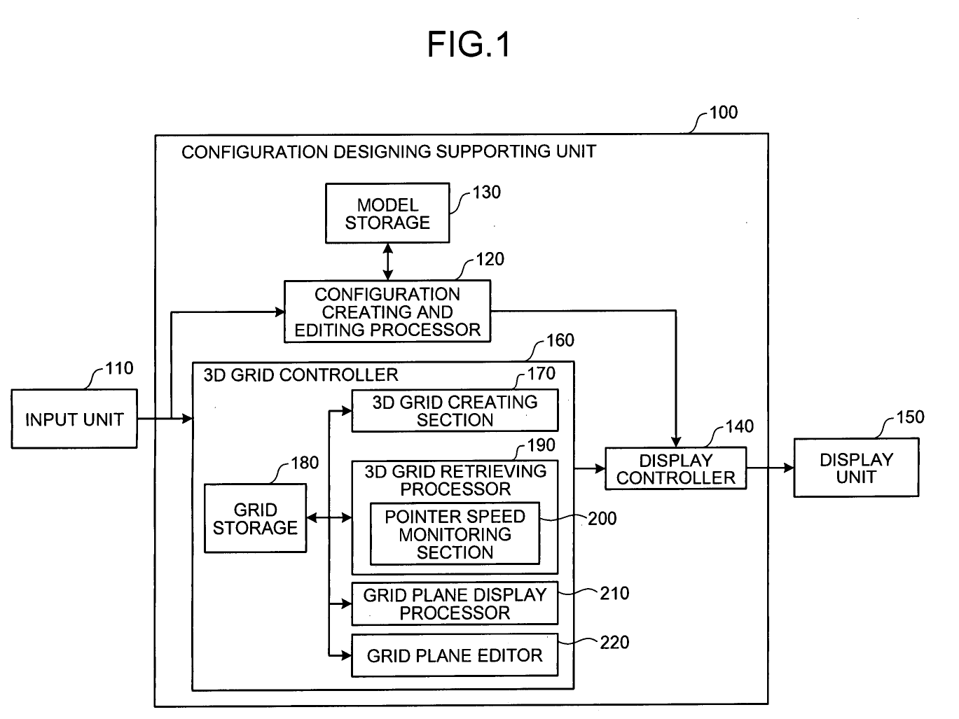

FIG. 1 is a functional block diagram of the structure of the configuration designing supporting unit 100 according to the first embodiment. The configuration designing supporting unit 100 is connected to an input unit 110 and a display unit 150, and includes a configuration creating and editing processor 120, a model storage 130, a display controller 140, and a 3D grid controller 160.

The input unit 110 is an input device such as a keyboard and a mouse. The input unit 110 inputs dimensions of a model configuration, a range in which the 3D grid is displayed, and a distance at which the 3D grids are displayed. In this case, the 3D grid means a grid that is displayed in the 3D space.

The configuration creating and editing processor 120 creates the model configuration based on the dimensions of the model configuration acquired from the input unit 110. The configuration creating and editing processor 120 stores data of the model configuration (hereinafter, “configuration data”) that is created in the model storage 130, as well as passes the configuration data to the display controller 140.

The model storage 130 stores the configuration data. The display controller 140 receives the configuration data from the configuration creating and editing processor 120, and based on the configuration data, displays the configuration corresponding to the configuration data on the display unit 150 such as a display. The display controller 140 receives data related to the 3D grid from the 3D grid controller 160, and displays the 3D grid on the display unit 150.

The 3D grid controller 160 performs a process related to creating the 3D grid, and includes a 3D grid creating section 170, a grid storage 180, a 3D grid retrieving processor 190, a grid plane display processor 210, and a grid plane editor 220.

The 3D grid creating section 170 acquires data related to a range of the 3D grid and a distance between the 3D grids, from the input unit 110, and creates the 3D grid. Moreover, the 3D grid creating section 170 stores data of the 3D grid (hereinafter, “3D grid data”) in the grid storage 180. The grid storage 180 stores the 3D grid data. Further, the grid storage 180 acquires information such as information designating the display range and the position of the 3D grid, from the input unit 110, and stores that information.

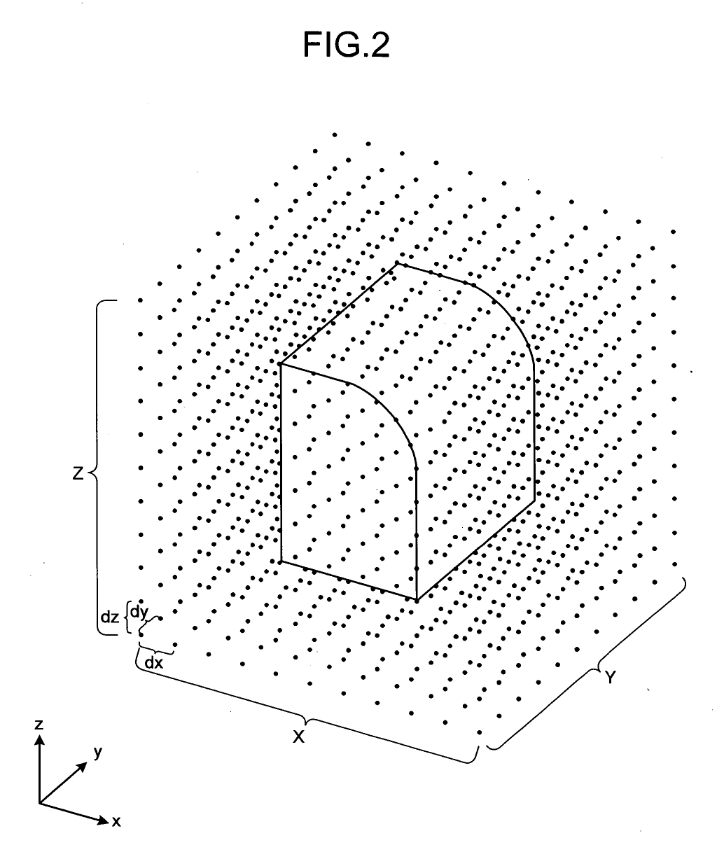

FIG. 2 is a diagram in which the 3D grid created by the 3D grid creating section 170 is shown by dots. Each 3D grid shown in FIG. 2 is created based on the range of the 3D grid and the distance between the 3D grids that are acquired from the input unit 110. In an example shown in FIG. 2, in the 3D space, the range in which the 3D grid is displayed is X in a direction of x-axis, Y in a direction of y-axis, and Z in a direction of z-axis, and the distance between the two 3D grids is dx in the direction of x-axis, dy in the direction of y-axis, and dz in the direction of z-axis. The dots of the 3D grid are displayed by different colors according to coordinates of the dot.

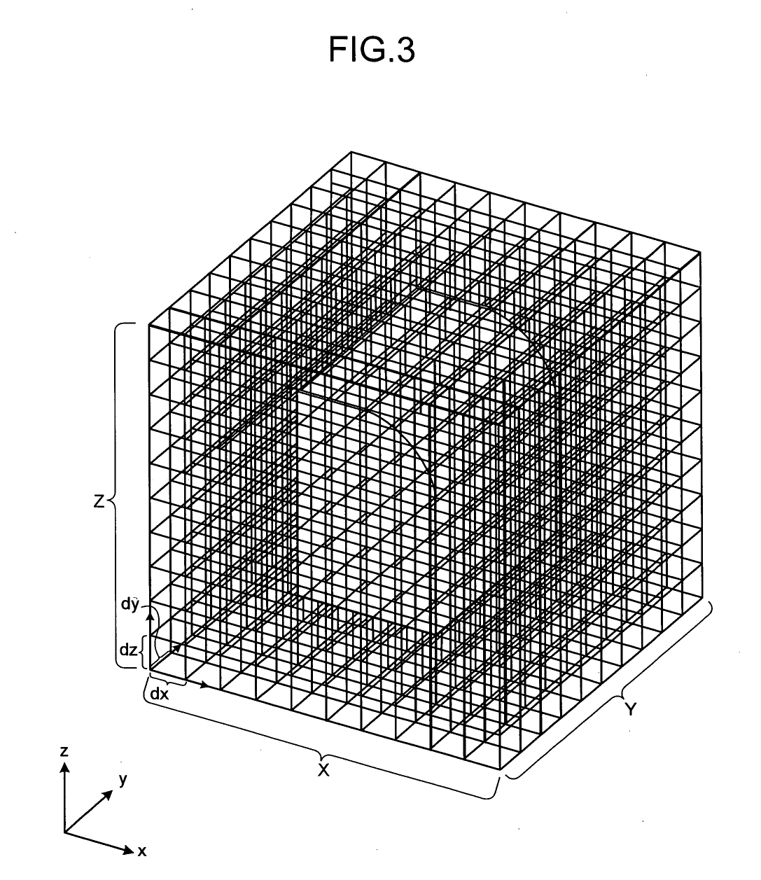

FIG. 3 is a diagram in which the 3D grid created by the 3D grid creating section 170 is shown by lattice points. The 3D grid shown by the lattice points is created similar to the 3D grid shown by the dots, based on the range of the 3D grid and the distance between the 3D grids that are acquired from the input unit 110. In an example shown in FIG. 3, in the 3D space, a range in which the 3D grid is displayed is X in the direction of x-axis, Y in the direction of y-axis, and Z in the direction of z-axis, and the distance between the two 3D grids is dx in the direction of x-axis, dy in the direction of y-axis, and dz in the direction of z-axis. The 3D grid in a form of the lattice points is displayed by different colors according to coordinates of the lattice points.

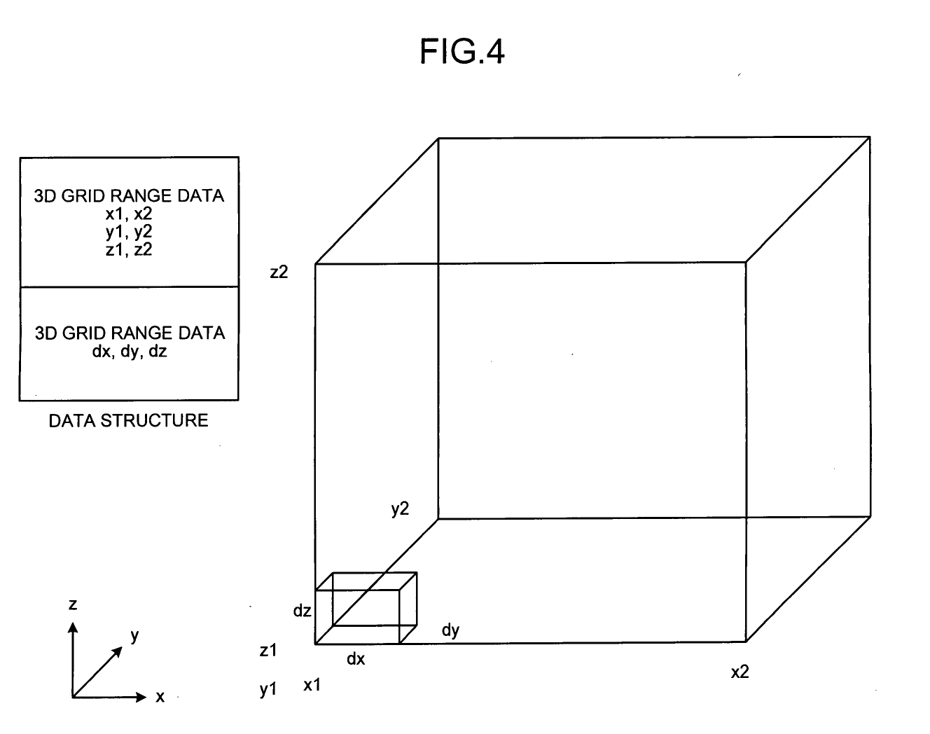

FIG. 4 illustrates the 3D grid data that is stored by the grid storage 180. The 3D grid data includes 3D grid range data and 3D grid distance data.

Here, the 3D grid range data stores information of the range in which the 3D grid is displayed, and the 3D grid distance data stores information related to a distance between a 3D grid and a neighboring 3D grid.

(x1, x2, y1, y2, z1, z2) are stored in the 3D grid data shown in FIG. 4. Therefore, the range in which the 3D grid is displayed is from x1 to x2 on x-axis, from y1 to y2 on y-axis, and from z1 to z2 on z-axis.

Moreover, the 3D grid distance data shown in FIG. 4 stores (dx, dy, dz). Therefore, a grid distance of the x-axis, a grid distance of the y-axis, and a grid distance of the z-axis related to each 3D grid are dx, dy, and dz respectively.

The 3D grid retrieving processor 190 acquires information about a moving speed of a pointer of the input unit 110. If the moving speed of the pointer is less than a certain speed, and if the pointer comes close within a certain distance from any 3D grid displayed in the 3D space, that particular 3D grid is retrieved as a target 3D grid from the grid storage 180, and a mouse pointer is allowed to snap the 3D grid that is retrieved.

The 3D grid retrieving processor includes a pointer speed monitoring section 200 that acquires information about the moving speed of the pointer from the input unit 110, and monitors the moving speed of the pointer.

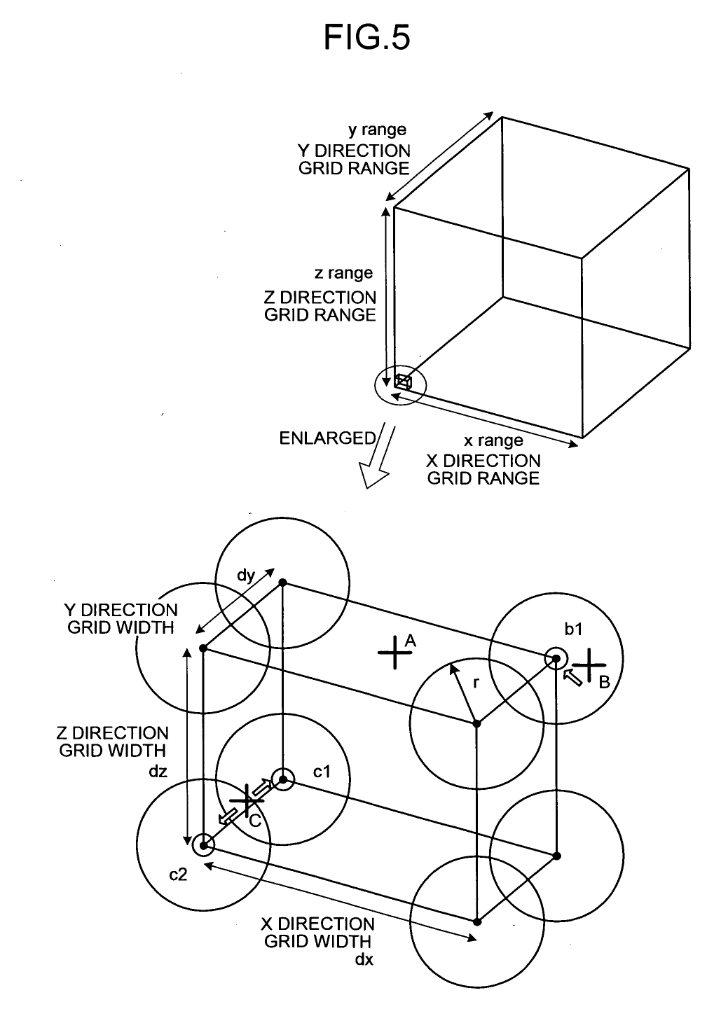

FIG. 5 illustrates snapping of the pointer of the input unit 110 to the 3D grid by the 3D grid retrieving processor 190. If the pointer is moving at a speed not less than a certain speed, or if the pointer is positioned at a point that is at a distance not less than a certain distance from each of the 3D grids as shown by a point A in FIG. 5, the 3D grid retrieving processor 190 does not allow the pointer to snap the 3D grid.

On the other hand, if the pointer of the input unit 110 is traveling at a speed less than the certain speed, and if the pointer is positioned at a point that is at a distance less than the certain distance from a specific grid (in FIG. 5, a 3D grid b1 for example) as shown by a point B in FIG. 5, the 3D grid retrieving processor 190 retrieves the 3D grid b1, and allows the pointer to snap the 3D grid b1.

Moreover, if the pointer of the input unit is traveling at a speed less than the certain speed, and if the pointer is positioned at a point that is at a distance less than the certain distance from a plurality of 3D grids (in FIG. 5, 3D grids c1 and c2 for example) as shown by a point C in FIG. 5, the 3D grid retrieving processor 190 retrieves a 3D grid that is closest (in FIG. 5, 3D grid c1 for example), and allows the pointer to snap the 3D grid c1.

A detailed description is omitted here. However, if the pointer of the input unit 110 is traveling at a speed less than the certain speed, and if the pointer is positioned at a point that is at a distance less than the certain distance from the plurality of 3D grids such as a point C, a user may be allowed to select a 3D grid subjected to snapping from among the plurality of 3D grids, and the pointer may be allowed to snap the 3D grid selected by the user.

The grid plane display processor 210 acquires information of designation of the display range and the position of the 3D grid (hereinafter, “range and position designation information”) from the grid storage 180, and based on the range and position designation information, displays only a 3D grid in the display range designated at a position that is designated. Hereinafter, the 3D grid displayed based on the range and position designation information is referred to as a 3D grid plane.

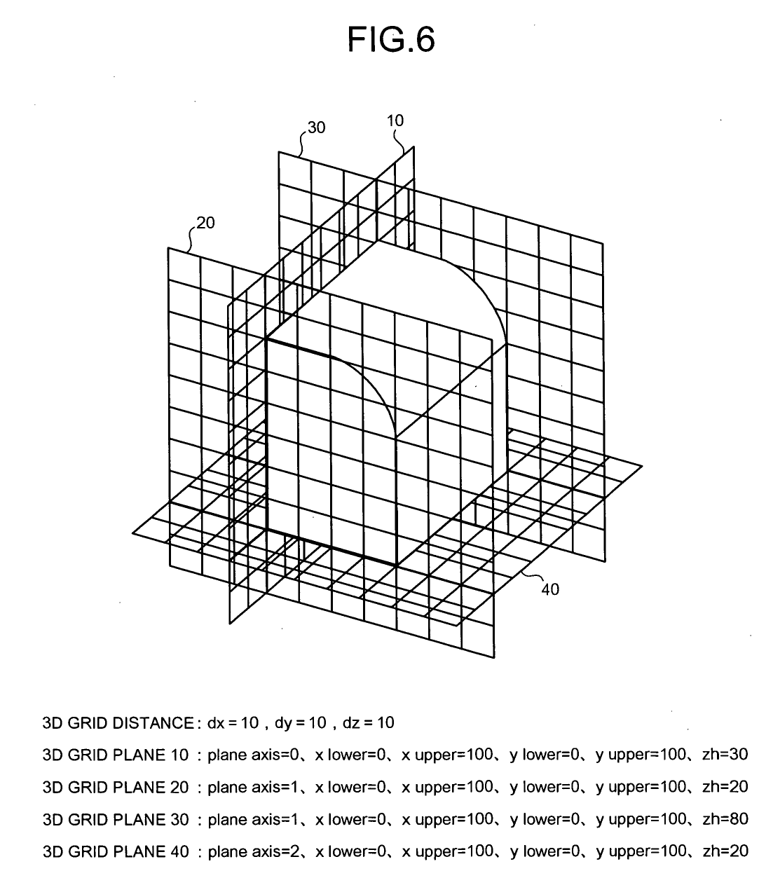

FIG. 6 is an example of a 3D grid plane that is displayed on the display unit 150 by the grid plane display processor 210 via the display controller 140. As shown in FIG. 6, if the range and position designation information is plane axis=0, x lower=0, x upper=100, y lower=0, y upper=100, and zh=30, the grid plane display processor 210 displays a 3D grid plane 10.

In this case, plane axis designates an axis. When plane axis=0, the x-axis is designated, when plane axis=1, the y-axis is designated, and when plane axis=2, the z-axis is designated.

x lower and x upper designate a range of a horizontal length of a plane that is orthogonal to an axis designated by plane axis. Therefore, when x lower=0 and x upper=100, the range of the horizontal length of the 3D grid plane is from 0 to 100.

y lower and x upper designate a range of a vertical length of the plane that is orthogonal to the axis designated by plane axis. Therefore, when y lower=0 and y upper=100, the range of the vertical length of the 3D grid plane is from 0 to 100.

zh designates a position of disposing a 3D grid plane that is orthogonal to the axis designated by plane axis. Therefore, when plane axis=0 and zh=30, a 3D grid plane that is orthogonal to the x-axis is displayed at a position of height 30 of the x-axis.

When the range and position designation information is plane axis=1, x lower=0, x upper=100, y lower=0, y upper=100, and zh=0, the grid plane display processor 210 displays a 3D grid plane 20.

When the range and position designation information is plane axis=1, x lower=0, x upper=100, y lower=0, y upper=100, and zh=80, the grid plane display processor 210 displays a 3D grid plane 30.

When the range and position designation information is plane axis=2, x lower=0, x upper=100, y lower=0, y upper=100, and zh=20, the grid plane display processor 210 displays a 3D grid plane 40.

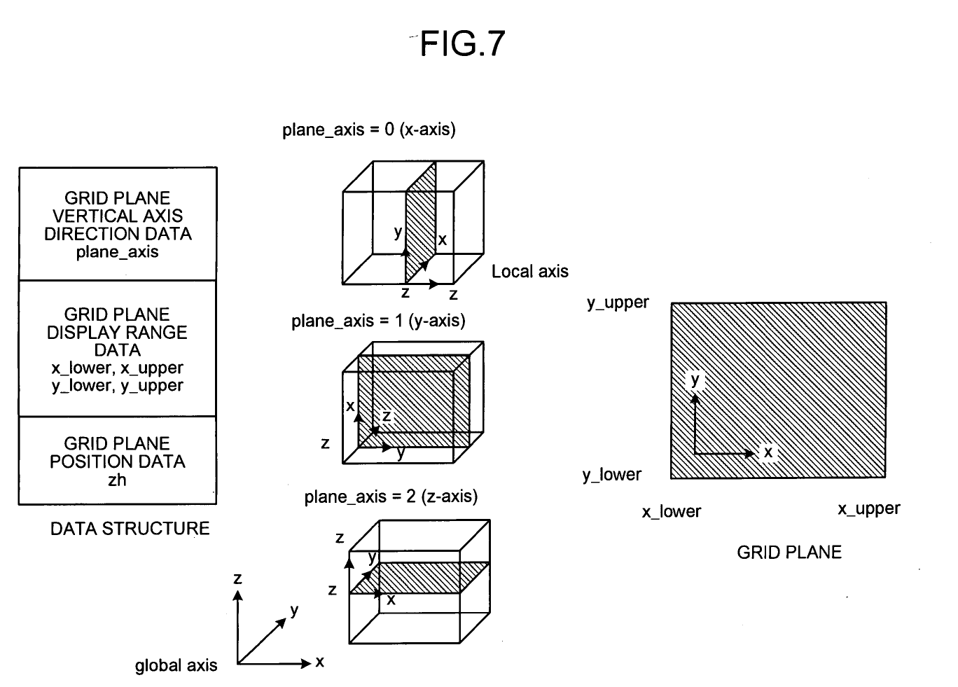

FIG. 7 is an example of a data structure of the 3D grid plane. As shown in FIG. 7, data of the 3D grid plane includes grid plane vertical axis direction data, grid plane display range data, and grid plane position data.

The grid plane vertical axis direction data includes information of designating an axis of the 3D grid plane. Concretely, information of either plane axis=0, or plane axis=1, or plane axis=2 is stored.

The grid plane display range data includes information of designating a range over which the 3D grid plane is displayed. Concretely, x lower, x upper, y lower, and y upper are stored in the grid plane display range data. In this case, x lower designates a minimum value related to the range of the horizontal length of the 3D grid plane that is diagonal to the axis designated by plane axis, and x upper designates a maximum value related to the range of the horizontal length of the 3D grid plane that is diagonal to the axis designated by plane axis.

y lower designates a minimum value related to the range of the vertical length of the 3D grid plane that is orthogonal to the axis designated by plane axis, and y upper is a maximum value related to the range of the vertical length of the 3D grid plane that is orthogonal to the axis designated by plane axis.

Information of designating the position of the 3D grid plane is stored in the grid plane position data. Concretely, zh that designates the position is stored in the grid plane position data. These data of the 3D grid plane are stored in the grid storage 180.

The grid plane display processor 210 passes the data of the 3D grid plane to the display controller 140. When the display controller 140 displays the 3D grid plane on the display unit 150, the display controller 140 changes a display color of the 3D grid plane based on a direction of the 3D grid plane.

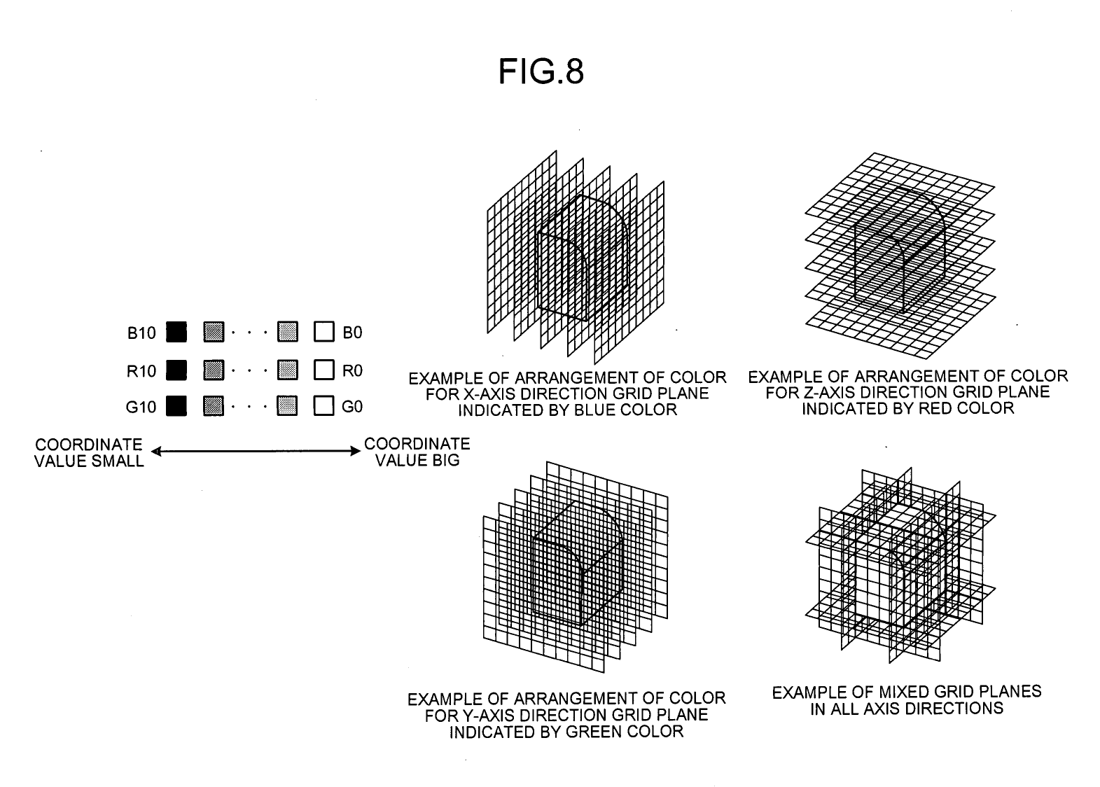

FIG. 8 is an illustration to describe the display color of the 3D grid plane. For example, while displaying the 3D grid plane in the direction of the x-axis, the display controller 140 displays the 3D grid plane in red color. While displaying the 3D grid plane in the direction of the y-axis, the display controller 140 displays the 3D grid plane in green color and while displaying the 3D grid plane in the direction of the z-axis, the display controller 140 displays the 3D grid plane in blue color. Therefore, even if the 3D grid planes in the direction of the three axes are mixed, the user can easily understand the direction of each of the 3D grids.

Moreover, the display controller 140 stores a color table for shades of each of blue, green, and red colors. The display controller 140 selects a lighter color from the color table as a coordinate value on each axis on which the 3D grid plane is positioned goes on increasing, and displays the 3D grid plane in the color selected.

The grid plane editor 220 receives instructions from the input unit 110, and edits the position and the display range of the 3D grid. Concretely, when any 3D grid plane is selected and an instruction to raise the position of the 3D grid plane is received from the input unit 110, the grid plane editor 220 raises the position of the 3D grid plane according to the instruction to raise, and displays the 3D grid plane of which the position is raised, on the display unit 150 via the display controller 140.

Further, when any 3D grid plane is selected and an instruction to lower the position of the 3D grid plane is received from the input unit 110, the grid plane editor 220 lowers the position of the 3D grip plane according to the instruction to lower, and displays the 3D grid plane of which the position is lowered, on the display unit 150 via the display controller 140.

When any 3D grid plane is selected and an instruction to increase the display range of the 3D grid plane is received from the input unit 110, the grid plane editor 220 increases the display range of the 3D grid plane according to the instruction to increase, and displays the 3D grid plane of which the display range is increased, on the display unit 150 via the display controller 140.

When any 3D grid plane is selected and an instruction to decrease the display range of the 3D grid plane from the input unit 110, the grid plane editor 220 decreases the display range of the 3D grid plane according to the instruction to decrease, and displays the 3D grid plane of which the display range is decreased, on the display unit 150 via the display controller 140.

When any 3D grid plane is selected and an instruction to copy the 3D grid plane is received from the input unit 110, the grid plane editor 220 copies the 3D grid plane selected, and displays a 3D grid plane copied, at a designated position. When any 3D grid plane is selected and an instruction to delete the 3D grid plane is received from the input unit 110, the grid plane editor 220 deletes the 3D grid plane selected.

Thus, based on the instructions to raise and lower or the instructions to increase and decrease, the grid plane editor 220 changes the position or the display range of the 3D grid plane. This enables the user to edit the 3D grid plane efficiently, thereby improving the efficiency of designing.

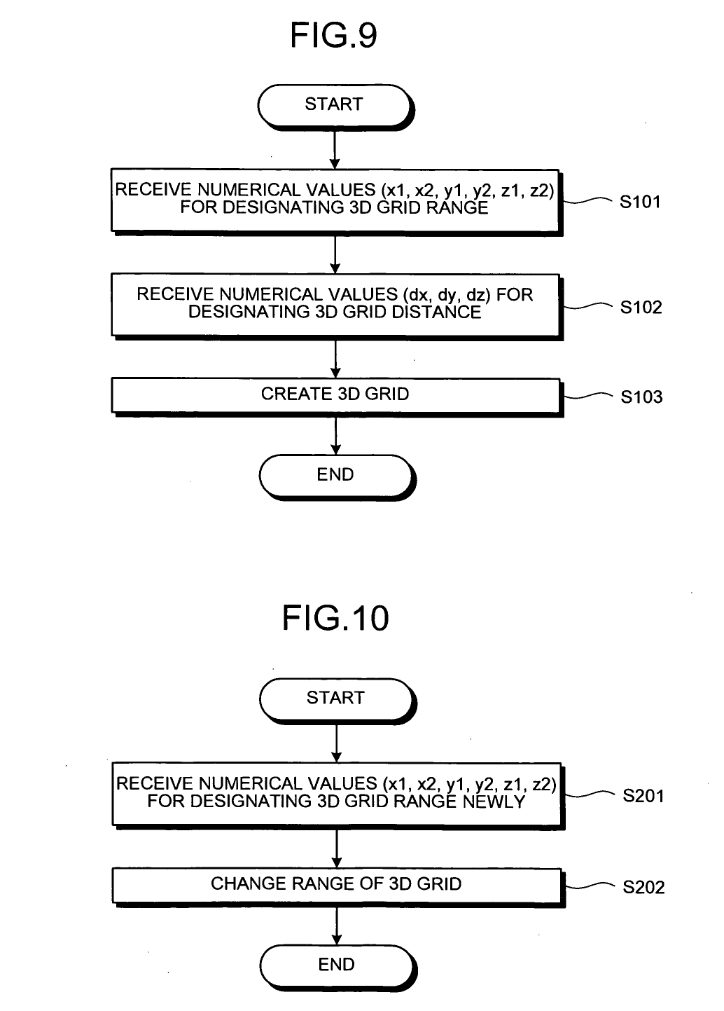

Next, a process of creating a 3D grid, executed by the 3D grid creating section 170, is described with reference to a flowchart in FIG. 9.

As shown in FIG. 9, the 3D grid creating section 170 receives numerical values (x1, x2, y1, y2, z1, z2) for designating the range of the 3D grid (step S101), and information for designating the distance between the 3D grids (step S102), and creates the 3D grid (step S103).

Next, a process of changing the range of the 3D grid, executed by the 3D grid creating section 170, is described with reference to a flowchart in FIG. 10.

As shown in FIG. 10, the 3D grid creating section 170 receives the numerical values (x1, x2, y1, y2, z1, z2) for designating the range of the 3D grid newly (step S201), and changes the range of the 3D grid (step S202).

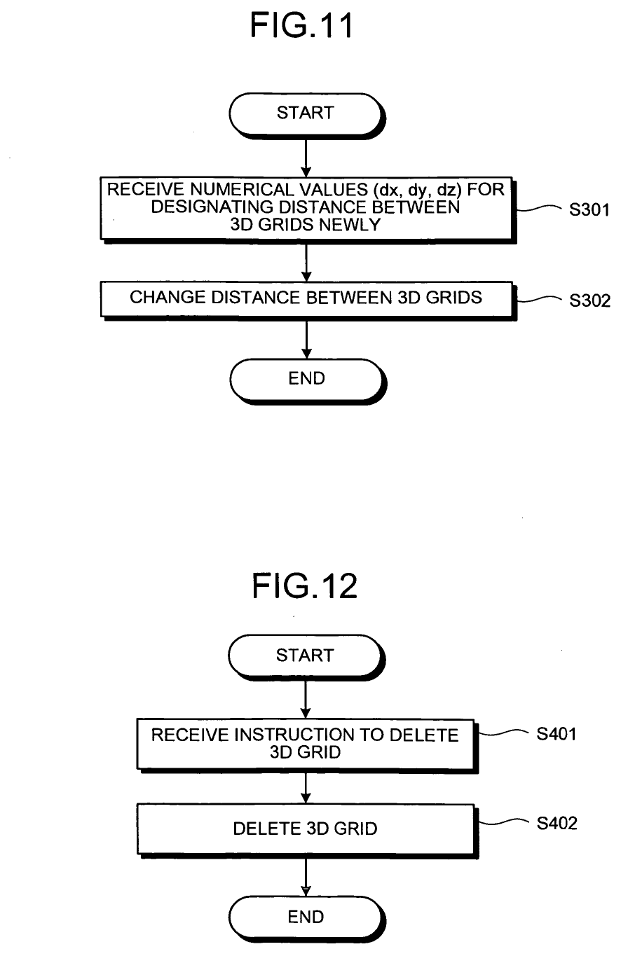

Next, a process of changing the distance between the 3D grids executed by the 3D grid creating section 170 is described with reference to a flowchart in FIG. 11.

As shown in FIG. 11, the 3D grid creating section 170 receives numerical values (dx, dy, dz) for designating the distance between the 3D grids newly (step S301), and changes the distance between the 3D grids (step S302).

Next, a process of deleting the 3D grid executed by the 3D grid creating section is described with reference to a flowchart in FIG. 12.

As shown in FIG. 12, the 3D grid creating section 170 receives an instruction to delete the 3D grid (step S401), and deletes the 3D grid (step S402).

Thus, the 3D grid creating section 170 receives the numerical values for instructing the range of the 3D grid and the distance between the 3D grids, and creates the 3D grid. When the 3D grid creating section 170 receives the numerical values for designating the range of the 3D grid newly, or the distance between the 3D grids newly, or the instruction to delete, the 3D grid creating section 170 renews or deletes the 3D grid. This enables the user to change the range of the 3D grid and the distance between the 3D grids easily.

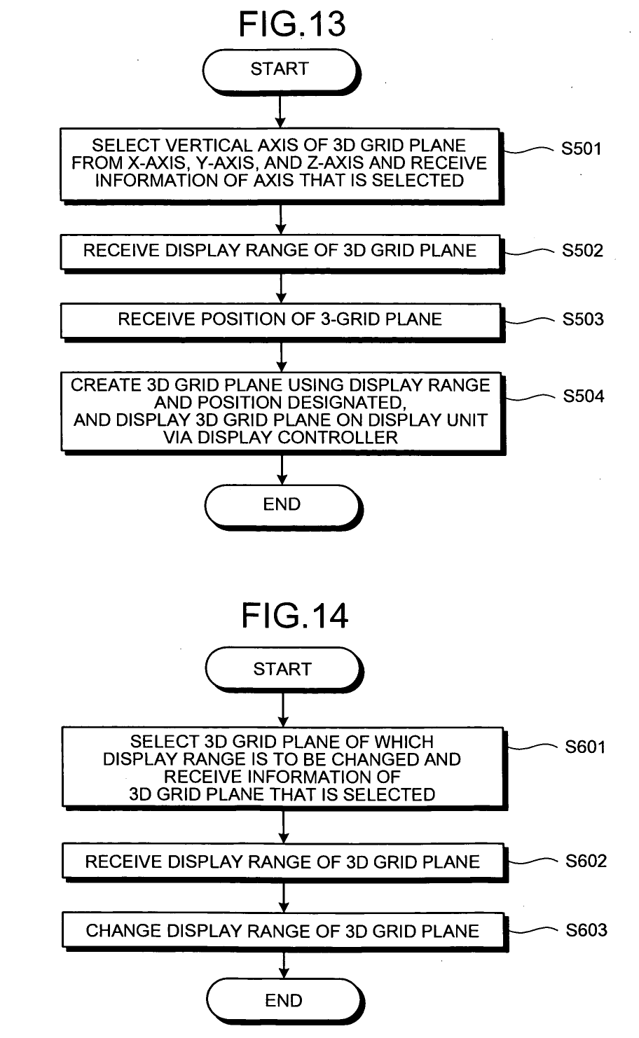

Next, a process of displaying the 3D grid plane on the display unit 150 via the display controller 140, executed by the grid plane display processor 210 is described with reference to a flowchart in FIG. 13.

As shown in FIG. 13, a vertical axis with respect to the 3D grid plane is selected form the x-axis, the y-axis, and the z-axis, and information of the axis selected is received (step S501). Then, the display range of the 3D grid plane is received (step S502), and the position of the 3D grid plane is received (step S503). The grid plane display processor 210 creates the 3D grid plane with the display range and position designated, and displays the 3D grid plane on the display unit 150 via the display controller 140 (step S504).

Thus, because the grid plane display processor 210 displays the 3D grid plane of which the range and the position are designated by the user, it is possible to improve the efficiency of configuration designing performed by the user.

The display range of the 3D grid plane may be designated by inputting the numerical values or by designating a rectangular area using a mouse. The position of the 3D grid plane may be designated by inputting the numerical values or using the mouse. Thus, by designating the position or the display range of the 3D grid plane with the mouse, the user can designate the 3D grid plane intuitively, thereby improving the designing efficiency.

Next, a process of changing the display range of the 3D grid plane, executed by the grid plane editor 220 is described with reference to a flowchart in FIG. 14.

As shown in FIG. 14, a 3D grid plane of which the display range is to be changed is selected, and information of the 3D grid plane selected is received (step S601). Then, the display range of the 3D grid plane is received (step S602), and the grid plane editor 220 changes the display range of the 3D grid plane (step S603).

Thus, because the user can change the display range of the 3D grid plane flexibly, the efficiency of a configuration designing job performed by the user improves. When the display range of the 3D grid plane is to be designated newly, the display range may be designated by inputting the numerical values, or by designating the rectangular area using the mouse.

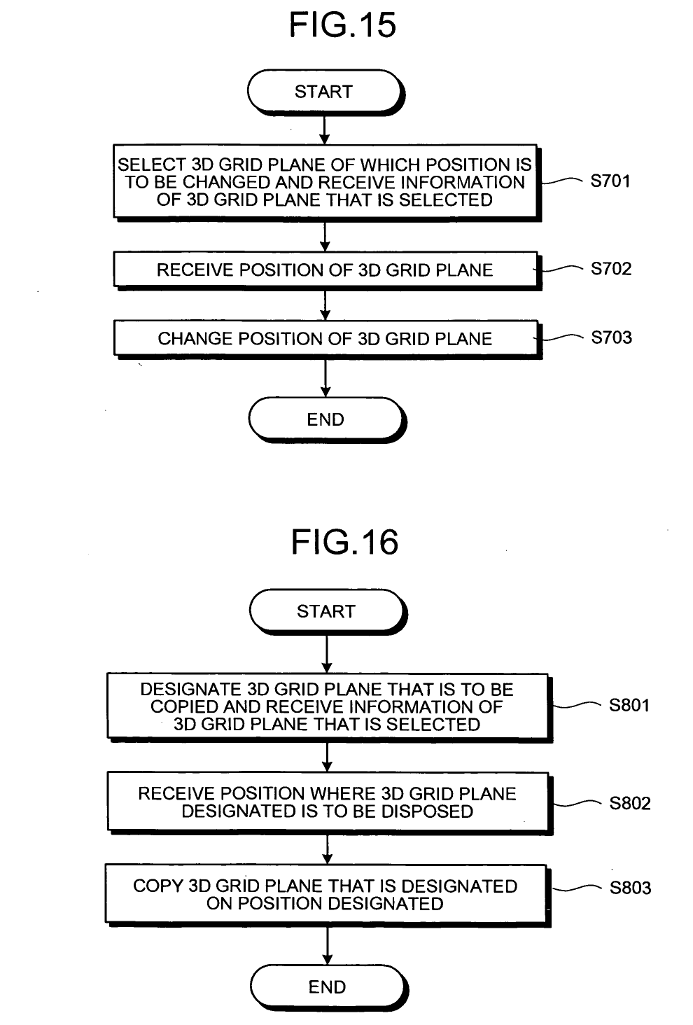

Next, a process of changing the position of the 3D grid plane, executed by the grid plane editor 220 is described with reference to a flowchart in FIG. 15.

As shown in FIG. 15, a 3D grid plane of which the position is to be changed is selected, and information of the 3D grid plane selected is received (step S701). Then, the position of the 3D grid plane is received (step S702), and the grid plane editor 220 changes the position of the 3D grid plane (step S703).

Thus, because the user can change the position of the 3D grid plane flexibly, the efficiency of the configuration designing job performed by the user improves. When the position of the 3D grid plane is to be designated newly, the position may be designated by inputting the numerical values or using the mouse.

Next, a process of copying the 3D grid plane, executed by the grid plane editor 220 is described with reference to a flowchart in FIG. 16.

As shown in FIG. 16, a 3D grid plane that is to be copied is selected, and information of the 3D grid plane selected is received (step S801). Then, the position where the 3D grid plane designated is disposed is received (step S802), and the 3D grid plane designated is copied (step S803).

Thus, because the 3D grid plane can be copied easily in a position designated, the designing efficiency of the user improves. The position at which the 3D grid plane is copied may be designated by inputting the numerical values, or using the mouse.

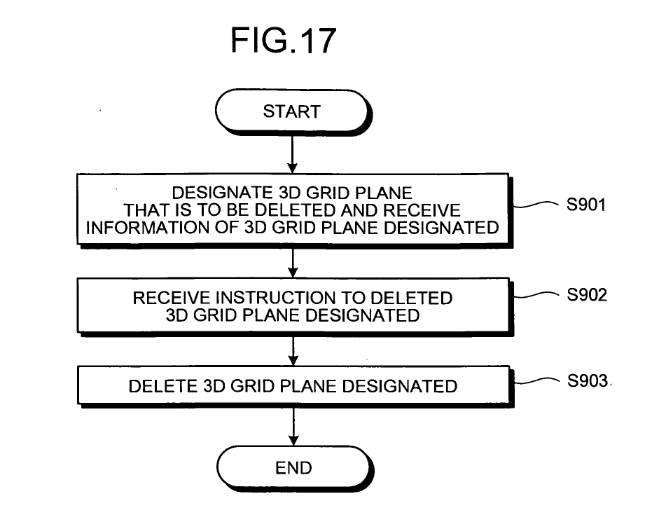

Next, a process of deleting the 3D grid plane, executed by the grid plane editor 220 is described with reference to a flowchart in FIG. 17.

As shown in FIG. 17, a grid plane that is to be deleted is selected, and information of the 3D grid plane selected is received (step S901). Then, an instruction to delete the 3D grid plane is received (step S902), and the grid plane editor 220 deletes the 3D grid plane designated (step S903).

Thus, as described so far, according to the first embodiment, the 3D grid creating section 170 acquires the information of designating the display range of the 3D grid and the distance between the 3D grids from the input unit 110, and creates the 3D grid with the range and the distance designated. Then, the grid plane display processor 210 acquires the range and position designation information, and displays the 3D grid plane having the display range and the position designated by the range and position designation information, on the display unit 150 via the display controller 140. Further, because the grid plane editor 220 edits the grid plane according to the instructions from the input unit 110, any coordinate value can be designated easily, for which the operation in the conventional 3D space has been complicated, thereby improving the designing efficiency.

According to the present invention, the range and position designation information is received from the input unit 110, and the 3D grid plane is displayed. However, by double clicking any 3D grid with the mouse, a 3D grid plane set in advance may be displayed with the double clicked 3D grid as a base point.

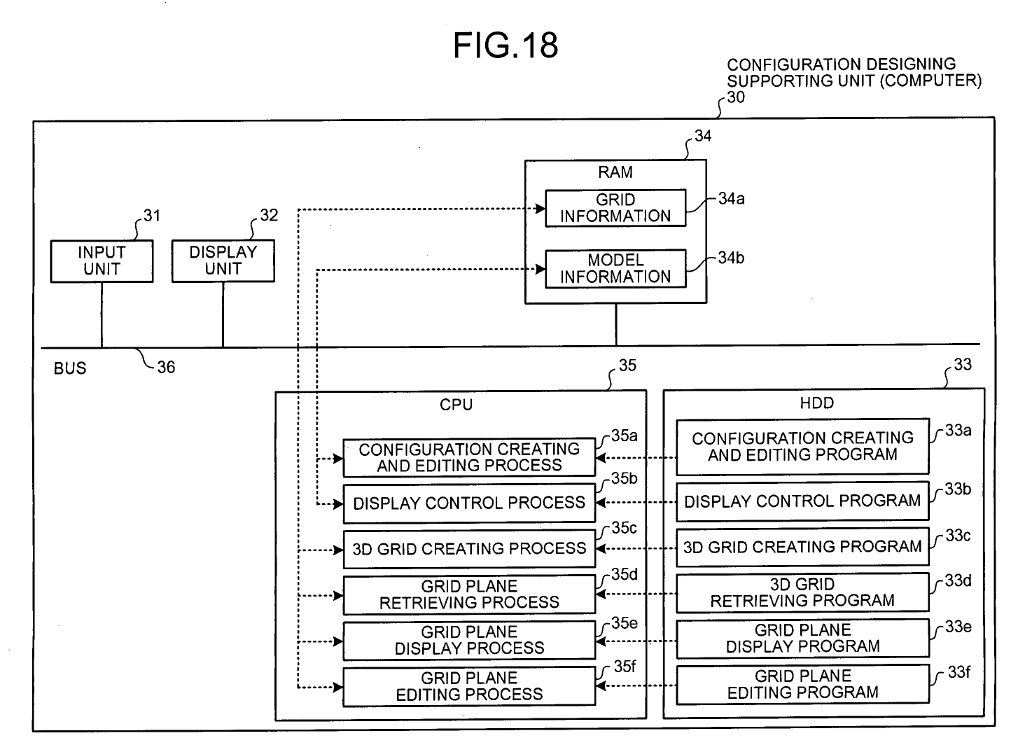

Incidentally, each process described in the first embodiment can be realized by executing in a computer a computer program that is prepared in advance. An example of a computer that executes a computer program to support the configuration designing that has similar functions as those according to the first embodiment is described by referring to FIG. 18. FIG. 18 is a diagram of the computer that executes the computer program to support the configuration designing.

As shown in FIG. 18, a computer 30 that is a configuration designing supporting unit includes an input unit 31, a display unit 32, a RAM (random access memory) 34, an HDD (hard disc drive) 33, and a CPU (central processing unit) 35 that are connected by a bus 36. The input unit 31 in this case, corresponds to the input unit 110 shown in FIG. 1, and the display unit 32 corresponds to the display unit 150.

The RAM 34 includes grid information 34a and model information 34b. The grid information 34a and the model information 34b correspond to the model storage 130 and the grid storage 180 respectively, shown in FIG. 1.

A computer program to support the configuration designing that delivers functions similar to those according to the first embodiment, is stored in advance in the HDD 33. In other words, a creating and editing configuration program 33a, a display control program 33b, a 3D grid creating program 33c, a 3D grid retrieving program 33d, a grid plane display program 33e, and a grid plane editing program 33f are stored in advance in the HDD 33. Elements of each of the computer programs 33a to 33f, as well as each component of the configuration designing supporting unit shown in FIG. 1 can be integrated or distributed appropriately.

The CPU 35 reads the computer programs 33a to 33f from the HDD 33, and executes them. By doing so, the computer programs 33a to 33f perform functions as a configuration creating and editing process 35a, a display control process 35b, a 3D grid creating process 35c, a 3D grid retrieving process 35d, a grid plane display process 35e, and a grid plane editing process 35f, respectively. The processes 35a to 35f correspond to the configuration creating and editing processor 120, the display controller 140, the 3D grid creating section 170, the 3D grid retrieving processor 190, the grid plane display processor 210, and the grid plane editor 220 shown in FIG. 1, respectively.

The computer programs 33a to 33f may not be stored necessarily in the HDD 33. The computer programs 33a to 33f may be stored in a portable physical medium such as a flexible disc (FD), a CD-ROM (compact disc—read only memory), an MO disc, a DVD (digital versatile disc), a magneto-optical disc, an IC card that is inserted in the computer 30, or in other computer, or a server connected to the computer 30 via a public line, the Internet, a LAN (local area network), and a WAN (wide area network), and may be read and executed by the computer 30.

According to the present invention, it is possible to improve a designing efficiency of the model configuration.

According to the present invention, the 3D grid can be displayed in a position intended by the designer.

According to the present invention, the 3D grid can be displayed in a range intended by the designer.

According to the present invention, the designer can specify the direction and a position of the 3D grid.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer program product that implements on a computer a method of displaying a three-dimensional grid in designing a model configuration, the method comprising:
acquiring grid space designation information that designates a width of the three-dimensional grid and a distance between two points of the three-dimensional grid;
acquiring grid plane designation information that designates a display width of the three-dimensional grid and a display position at which the three-dimensional grid is to be displayed; and
displaying only that portion of the three-dimensional grids that is defined by the grid space designation information and the grid plane designation information.

2. The computer program product according to claim 1, wherein the method further includes
acquiring a position shift instruction that contains any one of an instruction to raise the position of the three-dimensional grid and an instruction to lower the position of the three-dimensional grid; and
shifting a position of the three-dimensional grid displayed in accordance with the position shift instruction.

3. The computer program product according to claim 1, wherein the method further includes
acquiring a display width change instruction that contains data that indicates which portion of the three-dimensional grid displayed is to be redisplayed; and
redisplaying the three-dimensional grid based on the display width change instruction.

4. The computer program product according to claim 1, wherein the displaying includes
displaying lines of the three-dimensional grid in a different colors based directions of the lines.

5. The computer program product according to claim 1, wherein the displaying includes
displaying lines of the three-dimensional grid in a different gradations based on the display position of the three-dimensional grid.

6. The computer program product according to claim 1, wherein the method further includes
monitoring a moving speed of a mouse pointer; and
causing a pointer to snap the grid, if the moving speed of a mouse pointer is less than a predetermined speed, and if a distance between a position of the mouse pointer and a position of a grid is less than a predetermined distance.

7. A method of displaying a three-dimensional grid in designing a model configuration, comprising:
acquiring grid space designation information that designates a width of the three-dimensional grid and a distance between two points of the three-dimensional grid;
acquiring grid plane designation information that designates a display width of the three-dimensional grid and a display position at which the three-dimensional grid is to be displayed; and
displaying only that portion of the three-dimensional grids that is defined by the grid space designation information and the grid plane designation information.

8. The method according to claim 7, further comprising:
acquiring a position shift instruction that contains any one of an instruction to raise the position of the three-dimensional grid and an instruction to lower the position of the three-dimensional grid; and
shifting a position of the three-dimensional grid displayed in accordance with the position shift instruction.

9. The method according to claim 7, further comprising:
acquiring a display width change instruction that contains data that indicates which portion of the three-dimensional grid displayed is to be redisplayed; and
redisplaying the three-dimensional grid based on the display width change instruction.

10. The method according to claim 7, wherein the displaying includes
displaying lines of the three-dimensional grid in a different colors based directions of the lines.

11. The method according to claim 7, further comprising:
monitoring a moving speed of a mouse pointer; and
causing a pointer to snap the grid, if the moving speed of a mouse pointer is less than a predetermined speed, and if a distance between a position of the mouse pointer and a position of a grid is less than a predetermined distance.

12. A device that displays a three-dimensional grid in designing a model configuration, comprising:
a first acquiring unit that acquires grid space designation information that designates a width of the three-dimensional grid and a distance between two points of the three-dimensional grid;
a first acquiring unit that acquires grid plane designation information that designates a display width of the three-dimensional grid and a display position at which the three-dimensional grid is to be displayed; and
a displaying unit that displays only that portion of the three-dimensional grids that is defined by the grid space designation information and the grid plane designation information.
